(19) United States
(12) Patent Application Publication
(10) Pub. No.: US 2004/0117385 A1
(43) Pub. Date: Jun. 17, 2004

(54) Process of extracting people's full names and titles from electronically stored text sources

(76) Inventors: Donato S. Diorio, Hartland, WI (US); Igor S. Petrenko, Waukesha, WI (US)

Correspondence Address: JEFFREY FURR, 253 N. MAIN STREET, JOHNSTOWN, OH, 43031, US

(21) Appl. No.: 10/605,000

(22) Filed: Aug. 29, 2003

Related U.S. Application Data
(60) Provisional application No. 60/319,510, filed on Aug. 29, 2002.

(51) Int. Cl. G06F 17/00

(52) U.S. Cl. 707/100

(57) ABSTRACT

The invention is a process by which peoples names are extracted from electronically stored text. Electronically stored text constitutes any data stream that includes the standard ASCII characters. Examples of data streams are word processor, spreadsheet, or HTML files. The invention can find peoples names stored anywhere within the text of a website or other electronic data repository. A web site can be scanned and names of people listed on the website can be retrieved and stored into a user's database. When a name is identified within a stream of electronic text, additional information such as the person's job title can also be extracted.

### CROSS REFERENCE TO RELATED APPLICATIONS

This application claims the priority date of the Provisional Patent 60/319,510 filed Aug. 29, 2002.

### BACKGROUND OF INVENTION

1. Field of the Invention

This invention relates to the art of extracting data from electronically stored text sources, more specifically extracting people's full names and titles.

2. Description of Prior Art

Historically, research on companies was done with phone calls, as well as through subscriptions to proprietary databases. Typically these databases contain names and titles of people that work at a company as well as phone numbers. In recent years, email addresses have also been included in these databases. Two examples of database suppliers are Hoovers and Dun & Bradstreet.

In the mid to late 1990's, a large number of companies started to publish their own company websites on the Internet, accessible via the World Wide Web (WWW). Many of these companies are too small to be included in database directories. Unfortunately, there is not a standard for locating contact information stored within a web site. The only way to find contact information on these web sites is to use a web browser and search through pages. Sometimes a site map is available, but again, there is not a standard.

It is a common practice for companies to bury contact information several layers deep into their website. For example, a company that sells computers may have a technical support phone number listed, but not on their homepage. Some companies believe that if a person's name or phone number is too accessible, it might be abused. Additionally, a poorly designed web site may also be a challenge to navigate and thus difficult to find information.

Currently, prior art exists that reads a website and returns a sitemap of the contents of the website. What this accomplishes is essentially providing a sitemap for websites that lack sitemaps. The output from these systems consist of a tree structure breakdown of the web pages on the site. (6,237,006) (6,144,962).

Current art also exists that scans the web pages for email addresses. This is not unique and can be duplicated by any first year computer science student.

### SUMMARY OF INVENTION

The object of the present invention is to provide a method for extracting data from electronically stored text sources, more specifically extracting people's full names and titles.

The invention is a process by which peoples names are extracted from electronically stored text. Electronically stored text constitutes any data stream that includes the standard ASCII characters. Examples of data streams are word processor, spreadsheet, or HTML files. The invention can find peoples names stored anywhere within the text of a website or other electronic data repository. A web site can be scanned and names of people listed on the website can be retrieved and stored into a user's database. When a name is identified within a stream of electronic text, additional information such as the person's job title can also be extracted.

Definitions:

Whois: A program that will provide the owner's name of any 2nd-level domain name.

ASCII: American Standard Code for Information Interchange

WWW: World-Wide Web

GUI: Graphical User Interface

HTML: Hypertext Markup Language

URL: Uniform Resource Locator.

### BRIEF DESCRIPTION OF DRAWINGS

Description of figures

FIG. 1—Displays a user using the Internet

FIG. 2—Algorithm extraction states of example name combinations

FIG. 3—Name extraction algorithm flowchart

FIG. 4—Name normalization diagram

FIG. 5—Name probability decrements flowchart

FIG. 6—Name score Increments list in System

FIG. 7—Name score Decrements list in System

FIG. 8—Name score Special cases in System

FIG. 9—Default name score coefficients in System

FIG. 10—Formula for final name scoring algorithm

FIG. 11—Values for X[i], K[i], P[i]

FIG. 12—Name extraction formula variables

FIG. 13—Solving the final name scoring formula

FIG. 14—System Output results

### DETAILED DESCRIPTION

The preferred embodiment of the invention is described below.

The current invention uses Internet communications tool, browser, ISP (Internet Service Providers), embedded web-site, URL, protocols and languages that are known to one skilled in the art and therefore not disclosed here in detail.

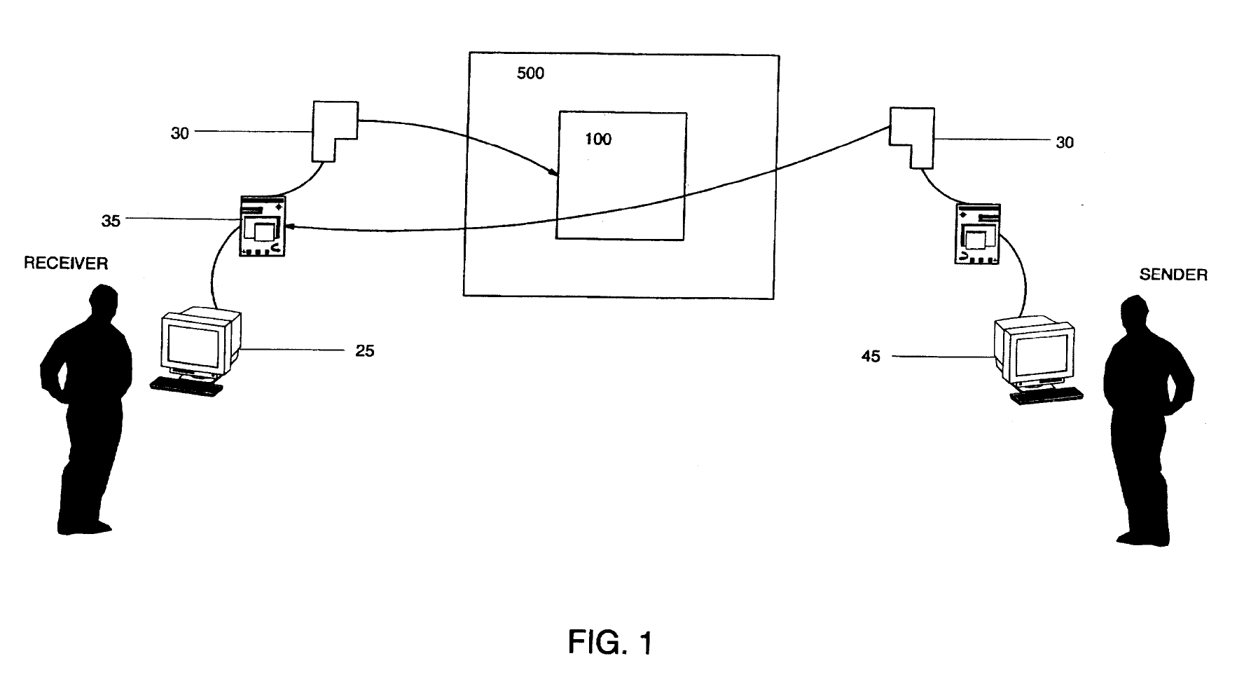

FIG. 1 illustrates a functional diagram of how a User 10 uses a computer 25 connected to the Internet 500. The computer 25 can be connected directly through a communication means such as a local Internet Service Provider, often referred to as ISPs, or through an on-line service provider like CompuServe, Prodigy, American Online, etc.

The Users 10 contacts the Internet 500 using an informational processing system capable of running an HTML compliant Web browser. A typical system that is used is a personal computer with an operating system such as Windows 95, 98 or ME or Linux, running a Web browser. The exact hardware configuration of computer used by the User 10 and the brand of operating system is unimportant to understand this present invention.

Those skilled in the art can conclude that any HTML (Hyper Text Markup Language) compatible Web browser is within the true spirit of this invention and the scope of the claims.

A computer application that includes the user interface for this invention will be henceforth be referred to as “the system 1.” The system 1 focuses on extracting text from HTML pages stored on an internet web site 100. However, the invention is not limited to working with HTML text.

The System 1 can find peoples names stored anywhere within the text of a website 100. This is a substantial time saver for any User 10 and therefore, it holds significant utility. A web site 100 can be scanned and names of people listed on the website 100 can be retrieved and stored into a user's database. When a name is identified within a stream of electronic text, additional information such as the person's job title can also be extracted.

The process of extraction relies on multiple component parts that work in conjunction to produce extraction results. Component categories include databases, algorithms, user interface, and output format.

Databases Elements

1. Names database.

2. Additional words databases (top 100 words, top 1000 words)

3. Titles database

4. Small databases (postal codes, directions, time)

5. Famous people database & historic figure database

Algorithm s in the System

1. Extraction algorithm

2. Substring scoring algorithm

3. Final name scoring algorithm

User Interface Elements

1. Substring score—Threshold increments

2. Substring score—Decrements

3. Substring score—Special cases

Output Format

1. The system output

Before describing the entire invention process, each element must first be defined.

Databases elements Names Database: This is known as the “Names” database. The names database includes over 2 million unique names. A unique name is defined as either a first or a last name. Some entries within the names database are both a first and a last name. Although it is called the names database, it includes more information than just names.

The names database consists of 7 fields:

Field 1: NAME: Contains either a first name or a last name.

Field 2: F: Boolean value that is true if the NAME field is a first name.

Field 3: L: Boolean value that is true if the NAME field is a last name.

Field 4: W: W is stored as a 2-byte integer. If W=0, then the NAME field in the same database record is not a word. If W>=1, then the NAME field is a word. Each bit within W denotes a word type (Noun, Verb, etc) that is used by the Substring scoring algorithm. As in the English language, a word can be classified as more than one word type. Example: both a noun and a verb.

Bit 1: Noun

Bit 2: Plural

Bit 3: Noun phrase

Bit 4: Verb

Bit 5: Verb Transitive

Bit 6: Verb Intransitive

Bit 7: Adjective

Bit 8: Adverb

Bit 9: Conjunction

Bit 10: Preposition

Bit 11: Interjection

Bit 12: Pronoun

Bit 13: Definite Article

Bit 14: Indefinite Article

Bit 15: Nominative

Field 5: A: The value of A determines if the NAME is also an area (city, state, etc.). If A=0, then the NAME field is not an area. If A>=1, then the NAME field is an area. Each bit within A denotes a match for a type of area. For example, a NAME can be both a city and a county.

Bit 1: NAME is a state or province abbreviation

Bit 2: NAME is a full state or province name

Bit 3: NAME is a city

Bit 4: NAME is a county

Bit 5: NAME is a country

Field 6: FF: The frequency that NAME occurs as a first name.

Field 7: FL: The frequency that NAME occurs as a last name.

Additional words databases (top 100 words, top 1000 words): The additional words databases each have one field. The top 1000 words database contains the 1000 most frequent words found in electronic text. The default form of the top 100 words database is a sub section of the top 1000 words database. Both of these databases are used to ignore frequently used words within electronically stored text. For purposes of speed, both the top 100 and top 1000 databases are embedded into the code of the System 1.

Titles database: The titles database includes job titles. Examples: President, Chief Financial Officer, Database Administrator.

Small databases: The small databases are also embedded into the code of the System 1. The small databases include; Postal codes database Contains 548 words listed by the US postal service as being a valid designator of an address (Lane, Road, Way, Annex, etc). Having these available to the extraction algorithm allows the System 1 to ignore names within found addresses. Example: 100 Mike Henry Blvd.

Directions database: Contains terms that designate direction. (North, South, Up, Down). These also help the algorithm ignore unwanted information.

Time database: Contains terms that designate time (Today, Daily, Noon)

Famous people database & historic figure databases: These databases are used to identify frequently used names such as “George Bush” to be recognized as text that does not constitute contact information. The names are not ignored as some people are named after famous people. However, it is used to change the statistical significance of the names found within text.

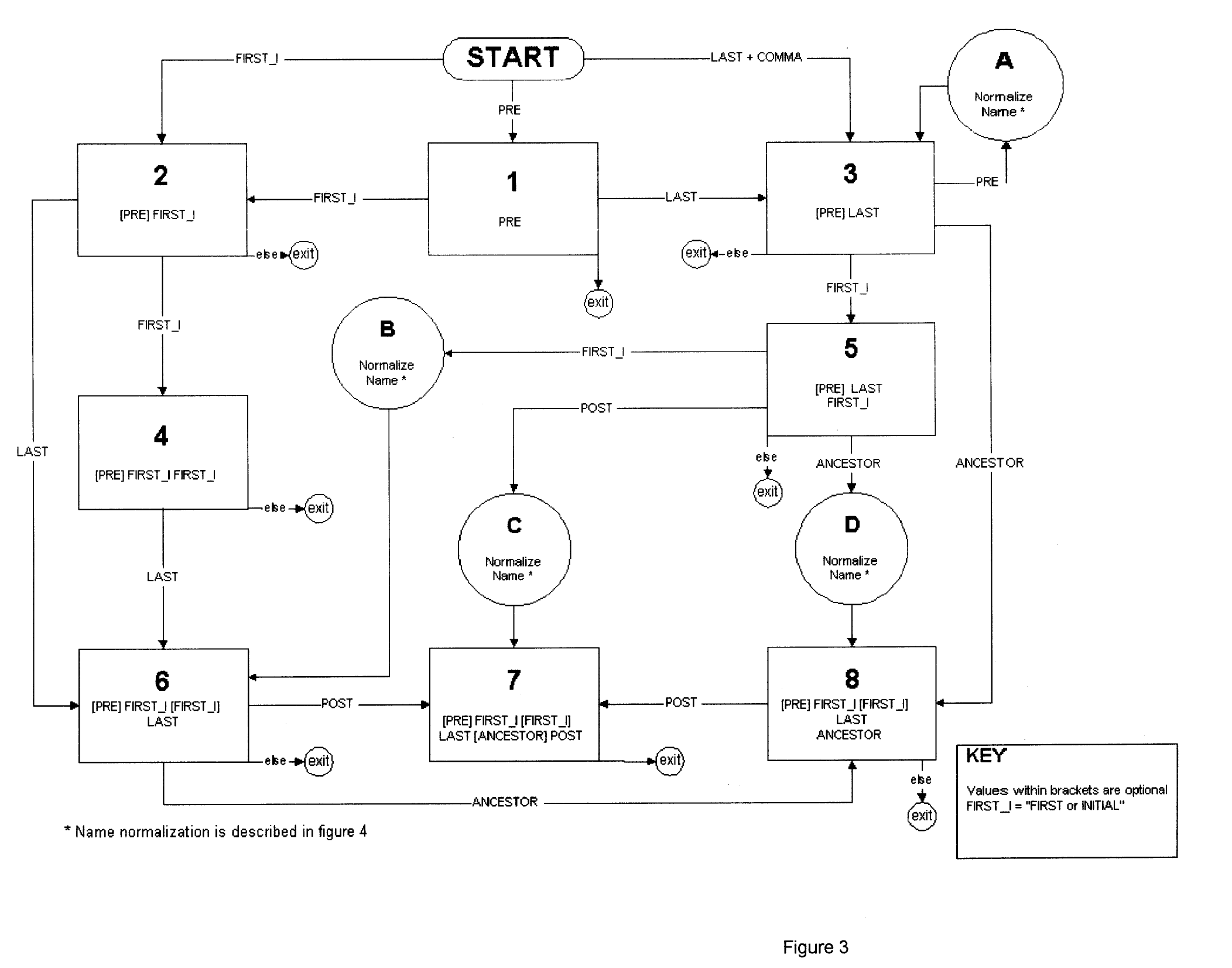

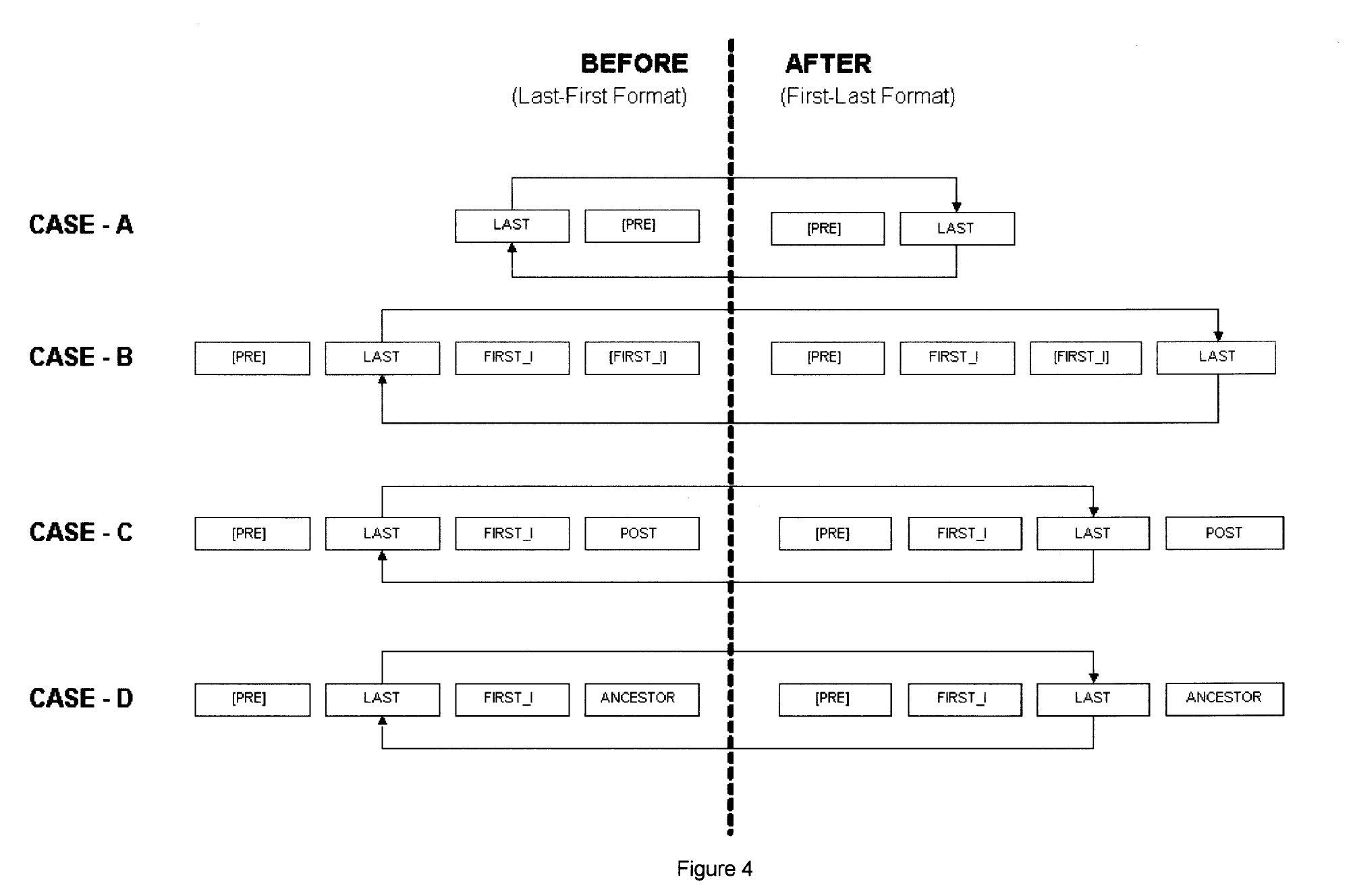

Algorithms in the system Extraction algorithm: The extraction algorithm is the part of the System 1 that scans a stream of electronic text and returns strings that match the criteria of a name. FIG. 3 shows a flowchart illustrating the states of the extraction algorithm. FIG. 4 shows the name normalization process that is sometimes used in conjunction with the extraction algorithm.

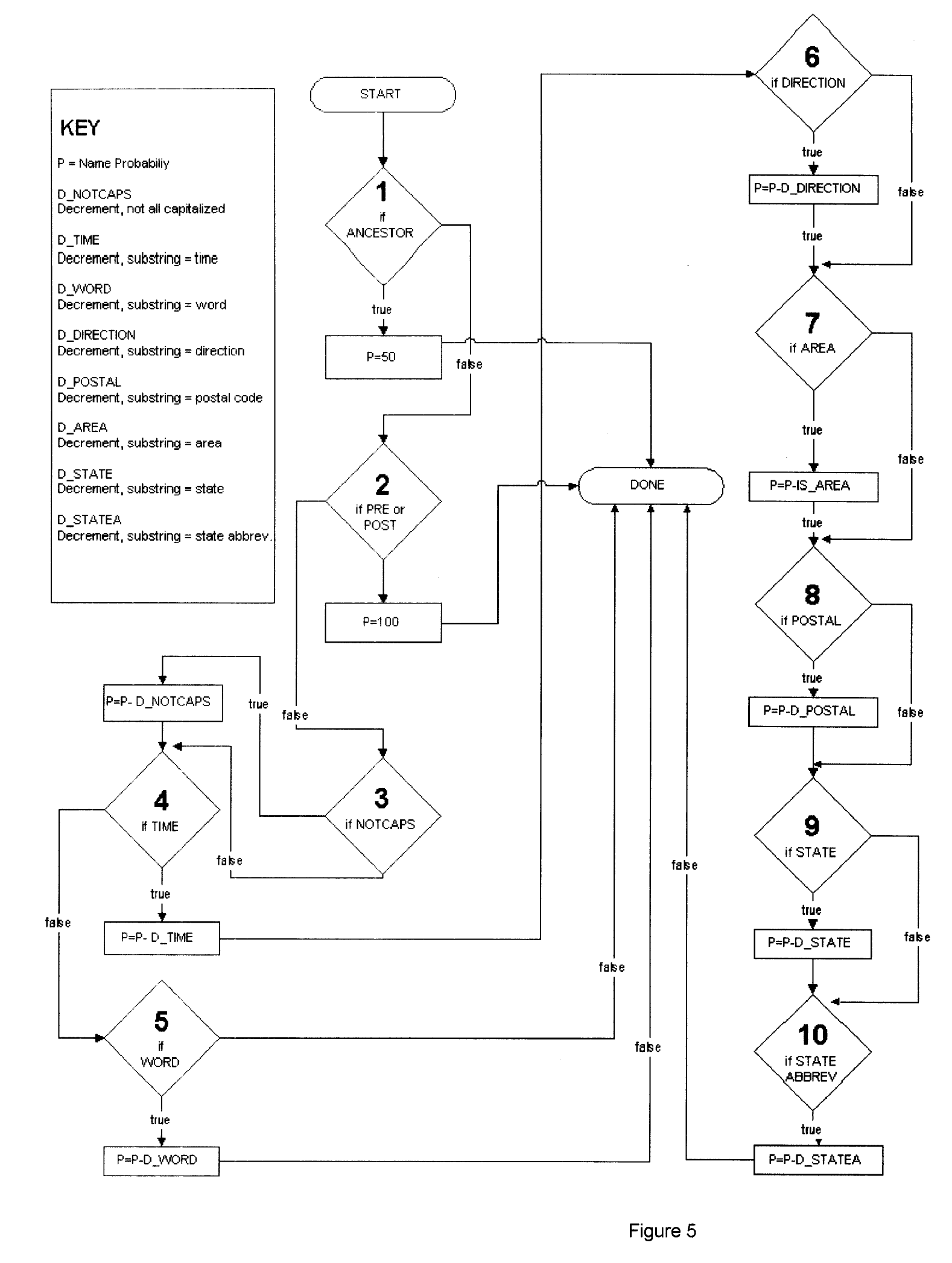

Substring scoring algorithm: The Substring scoring algorithm examines the string retrieved by the extraction algorithm and assigns it a numeric rank. All substrings processed by the Substring scoring algorithm start with the same value. A series of increments and decrements are then applied to the substring. FIG. 5 shows an example of the decrements applied by the Substring scoring algorithm.

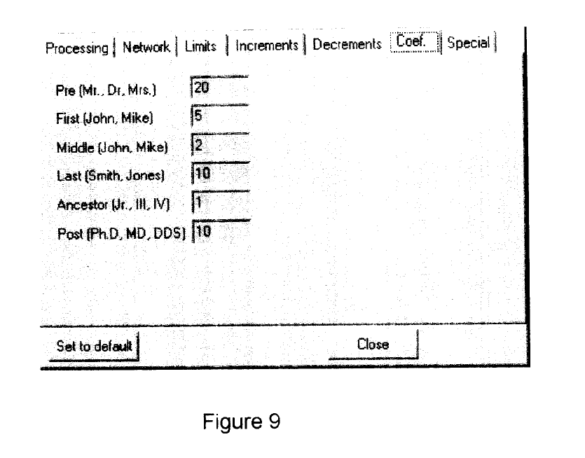

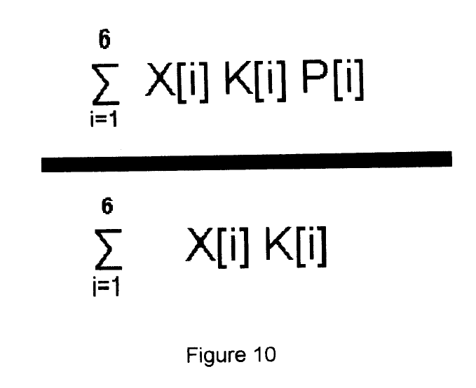

Final name scoring algorithm: Once each substring is scored by the substring scoring algorithm, the values for the name part coefficients are applied to the final scoring algorithm. FIG. 10 shows the formula used by the final name scoring algorithm. FIG. 9 shows the 6 coefficients (PRE, FIRST, MIDDLE, LAST, ANCESTOR, POST). It should be noted that the term “FIRST2” is used interchangeably with the term “MIDDLE.,” The “MIDDLE” label is used in the systems 1 user interface and the “FIRST2“label is used by the systems 1 internal processes.

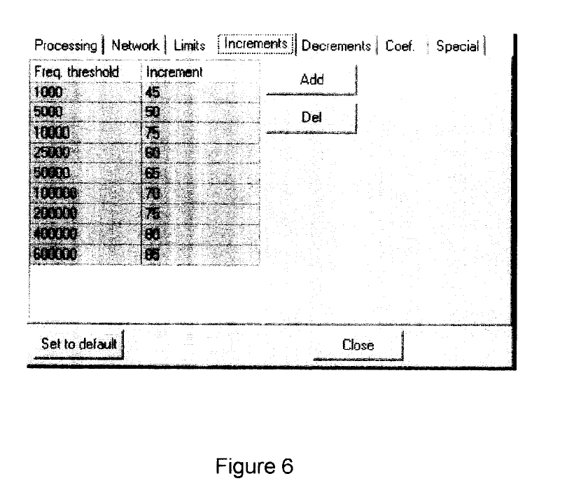

User Interface elements All User 10 interface elements described in this section are intended to be for an administrator level user. An administrator level user is a User 10 who has the rights to install the System 1 on a stand alone computer or computer network. Once the System 1 is installed, user interface elements are not editable. All variables set within the user interface of the System 1 are tied directly to the internal workings of the System 1 algorithms. User editable elements are shown FIGS. 6,7,8.

Increments: The frequency threshold increments are included in a user-editable grid that includes a list of frequency threshold values. Frequencies are stored in the Names database in the field FF and FL. Next to each frequency threshold is an increment value (FIG. 6). The substring scoring algorithm uses the increment values to increase the score of names found by the extraction algorithm. For example, the first name “John” has a frequency of 2,224,000 in the names database. The number 2,224,000 is larger than the highest frequency threshold (largest increment is 85), so “John” as a first name would get an increment of 85. “John” has a last name frequency of 9000 (greater than 5,000, but less than 10,000). The increment for “John” as a last name would be 45.

The user-editable grid allows modification of frequency thresholds, and therefore makes the System 1 more flexible. The preferred default values of the grid are shown in FIG. 6.

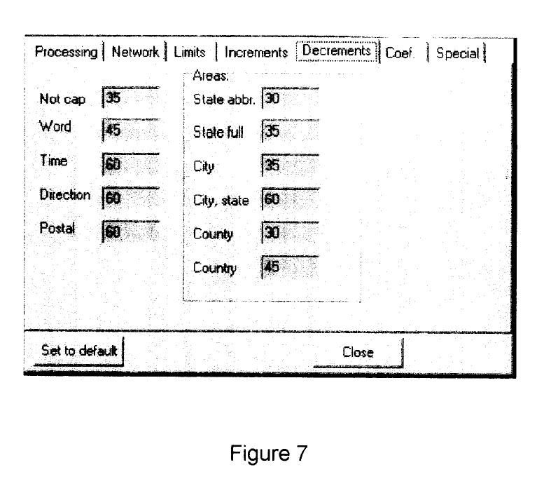

Decrements: Decrements are used to lower the ranking of substrings found extracted from text. Using decrements, names that have questionable elements in them are separated from pure names. Decrements are shown in FIG. 7. A pure name is a name in which no substring element is subject to a decrement. Decrements can be applied in the following ways; (1) As individual word within a name such as “Amber” (“Amber” is both a word and a name) in the name “Amber Smith;” (2) applied to the entire name such as “George Bush.” Each decrement, when true, decreases the substring score by the corresponding value set in the System 1 user interface.

List of Decrements:

Not caps: A word in an extracted name is not capitalized. Example “john Smith”

Area: The extracted name is also an area. Example; “Roberta Georgia” can be a woman's name and it is also a city in the state of Georgia.

Word: The extracted name contains a word.

Time: The extracted name contains a word in the time database.

Direction: The extracted name contains a word in the direction database.

Postal code: The extracted name contains a word in the postal code database.

State: The extracted name contains the name of a state.

State abbreviation: The extracted name contains a state abbreviation.

Famous person: The extracted name is listed in the famous person database.

Historic figure: The extracted name is listed in the historic figure database.

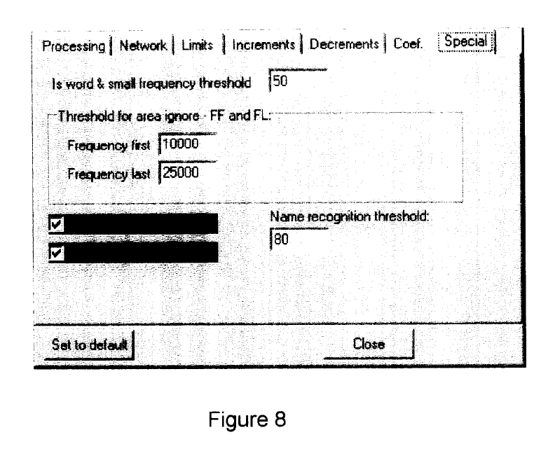

Special cases & values: Special case thresholds are used by the extraction algorithm and the substring scoring algorithm. See FIG. 8.

Name recognition threshold: Minimum value of a final name score required for the System 1 to display an extracted name.

Threshold area+first: If a first name is an AREA and the frequency of the first name is less than N1, then ignore the name. N1=value set in user interface.

Threshold area+last: If a last name is an AREA and the frequency of the last name is less than N2, then ignore the name. N2=value set in user interface.

Word+small frequency: If a first or last name is a WORD and the frequency of the name is less than the set value, and then ignore the name.

Sequential words+top 1000: If 2 sequentially extracted names are both WORDS and one of the 2 words is in the top 1000, then cut off the first word and re-enter the extraction algorithm.

Top 100: If a name includes a word in the top 100, then cut off the first word and re-enter the extraction algorithm.

How all the component parts work together to create the system:

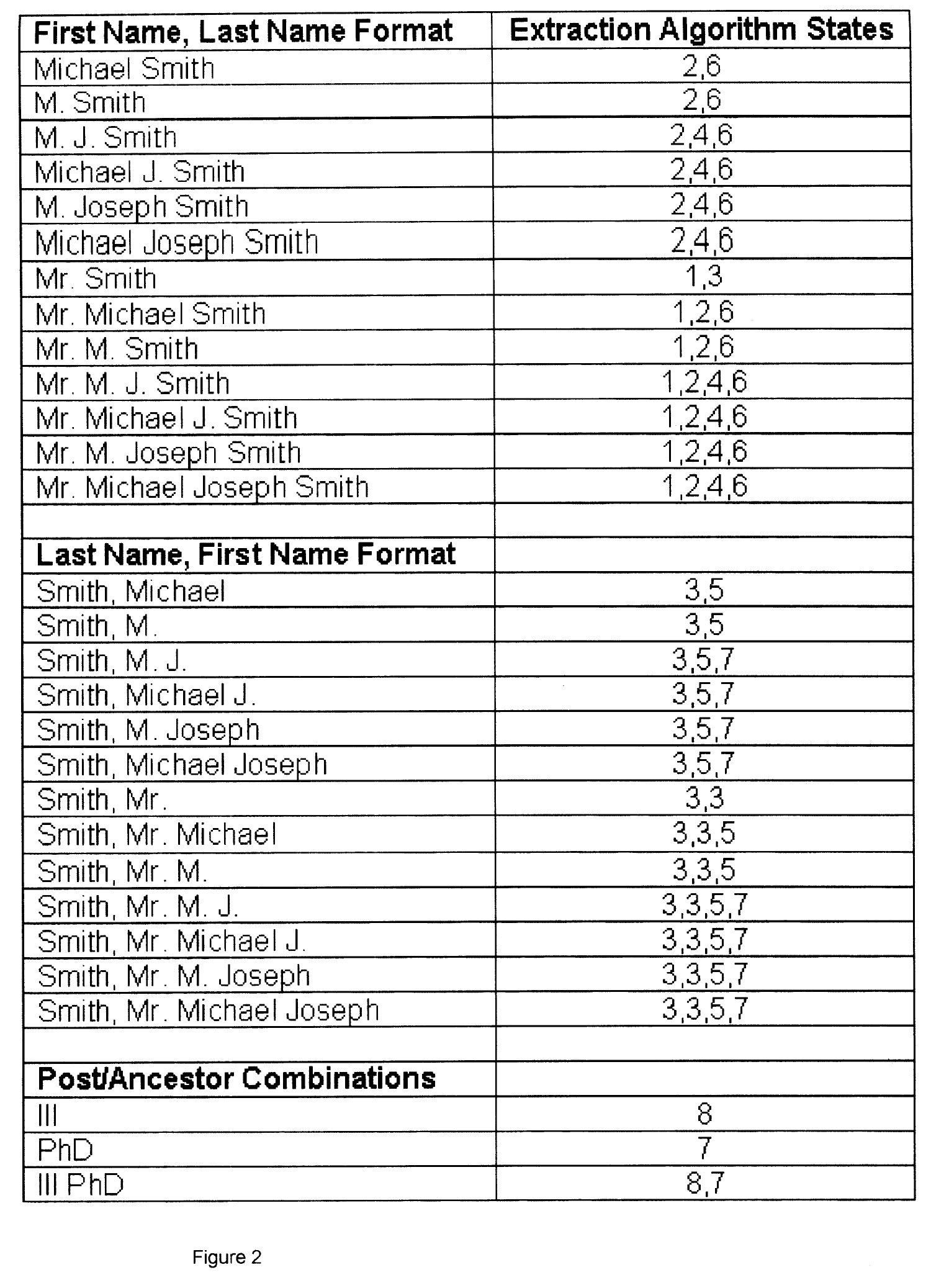

FIG. 2 shows combinations of the name of Mr. Michael Joseph Smith-Guterez III PhD as it could appear in electronically stored text. Combinations include names in First Name-Last Name format and Last Name-First Name format. The example name is being used because it includes all possible name part coefficients. “Guterez” is not present in combinations listed in FIG. 2. It is not considered a separate name by the extraction algorithm. It was included in the initial example to show the full extraction scope of the System 1.

Using FIG. 2, the extraction algorithm flowchart (FIG. 3) can be traced for any name combination. Use the “Extraction Algorithm States” column from FIG. 2 as a guide for algorithm flow.

The name extraction algorithm has 8 possible states (1-8) and 4 special cases (A-D). Each state represents a currently extracted string that contains a name or part of a name. For example, if the System 1 algorithm is at state #1 the only possible string that can exist is the PRE part of a name. A PRE name part includes designations such as Mr., Mrs., and Dr. In each state (FIG. 3) values represented in brackets are optional for that state. Values without brackets are required. For example, in state # 4, PRE is optional and both occurrences of FIRST_I are required. FIRST_I represents either a first name or initial. Example name substrings that can be found at state # 4 are the following:” Michael Joseph”, “M. Joseph”, “Michael J.”, “M. J”, “Mr. Michael Joseph”, “Mr. M. Joseph”, “Mr. Michael J.”, “Mr. M. J”.

In FIG. 2, the different combinations of the POST name coefficient and ANCESTOR name coefficient are shown under the title “Post/Ancestor Combinations”. The POST name coefficient is represented in the extraction algorithm as state #7. The ANCESTOR name coefficient is represented in the extraction algorithm as state #8. POST and ANCESTOR states have 3 possible combinations that are always appended to the end of the last name. The 3 combinations are shown in FIG. 2 under “Post/Ancestor Combinations.” Using FIG. 2 as a guide, any combination of the example name can be traced through states in the extraction algorithm (FIG. 3). For example, the combination, “Mr. Michael J. Smith” can be traced from states 1, to 2, to 4, to 6.

The flowchart of the extraction algorithm (FIG. 3) has 4 locations where a name substring can exist in LAST-FIRST format (after states 3 & 5). In each of these cases, the name must be normalized into FIRST-LAST format. FIG. 4 outlines the normalization process.

For future clarification, the term “final name scoring formula” refers to the mathematical formula used by the final name scoring algorithm. The “final name scoring algorithm” refers to the implementation of the “final name scoring formula” within the System 1.

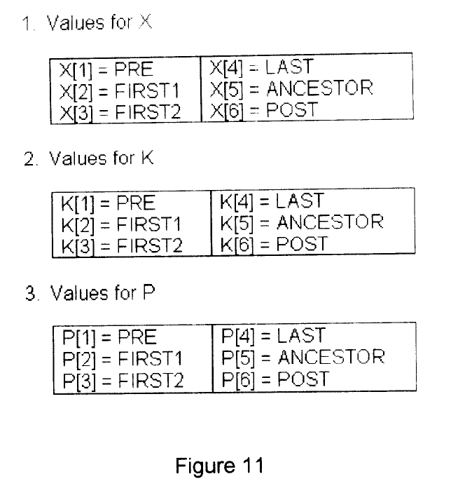

The final name scoring algorithm enables the System 1 to give a numeric score to each name extracted by the name extraction algorithm. If the score is greater than the name recognition threshold (set in the System 1 user interface), then the name is extracted and output by the System 1. If the final name score does not meet name recognition threshold, the first substring of the extracted name is ignored. The name extraction algorithm is then restarted, starting the process over at the second word in the skipped name. The formula used in the final name scoring algorithm is represented in FIG. 10. The breakdown of each variable from the final name scoring formula is shown in FIG. 11.

In FIG. 10, variable X[i] contains Boolean values representing the presence or absence of a name part. If the name part is found in the extraction process, then X[i]=1, otherwise X[i]=0.

Variable K[i] contains the coefficient values for the name part. Coefficients values are defined in the System 1 user interface (FIG. 9).

Variable P[i] represents the probability value set for each name part. The value for P is determined in the name extraction algorithm (FIG. 3). P[i] is set by the substring scoring algorithm.

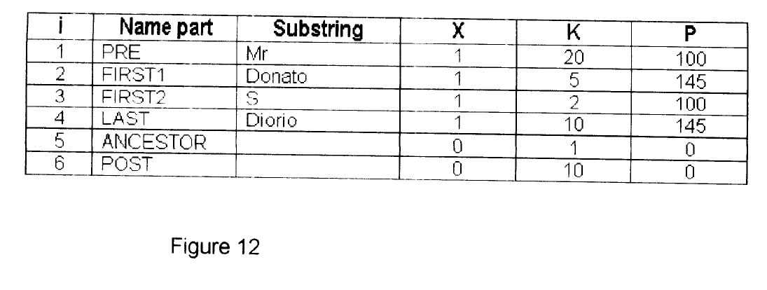

FIG. 12 shows the example name; “Mr Donato S. Diorio” extracted by the name extraction algorithm and then scored by the final name scoring algorithm. The name is divided into component substrings by name part coefficients. Each substring is represented by a different row. Values are shown for X[i], K[i], and P[i].

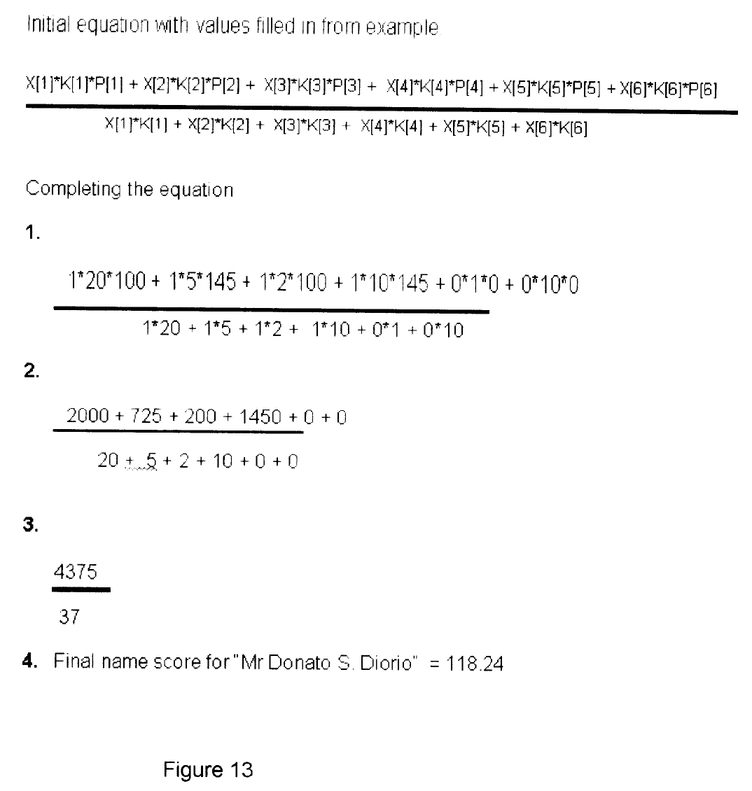

Using the final name scoring formula in FIG. 10, and the values from the example name in FIG. 12, the expanded formula would take the form shown in FIG. 13.

Title extraction:Once a name is extracted and it's score is above the name recognition threshold, a title is then scanned for. Scanning for job titles is accomplished by comparing the text directly before and directly after and an extracted name and comparing it to a database of existing titles. Multiple titles may match substrings in proximity to the extracted name. For example: the title “Vice President of Sales” also contains the substring “Vice President” which is also a title. As a rule, the System 1 chooses the longest matching substring for the extracted title. In this example, the System 1 would choose “Vice President of Sales.”

The System Output

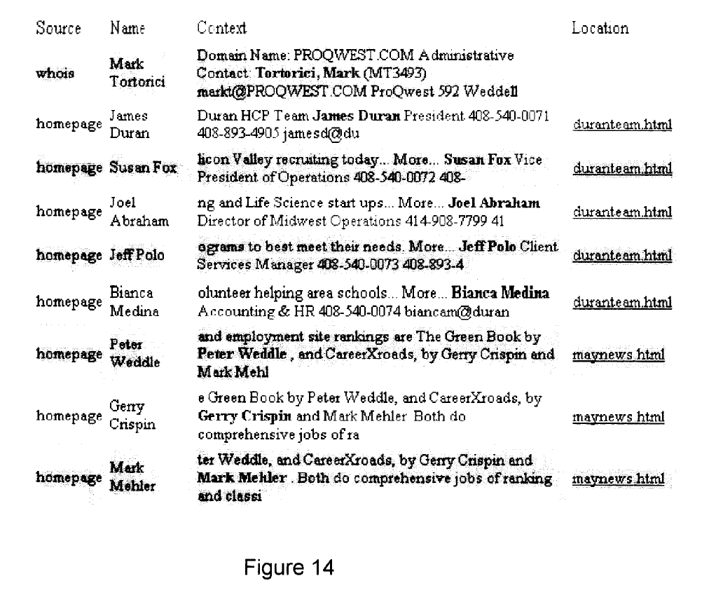

Once an extracted name has a score, it is saved by the System 1 and later output when scanning is complete. FIG. 14 shows a table of output results from the System 1. Output results from the System 1 are in HTML format and can be viewed with a web browser. In this example, the System 1 scanned an entire web site of a target company.

Each row of data includes columns;

Source: The source of the data. Source tells the User 10 where the name was found. For example, names can be found within who is information gathered from a who is server, or a name could be from scanning a web site

Name: The extracted name and optional title of a person.

Context: The context the name was found in. Showing the context is crucial for determining if the extracted name is a person related to the web site. In FIG. 14, the context for the extracted name “Peter Weddle” (row #7) shows that he is an author. Context gives the User 10 the information to make a choice as to if the name is significant.

Location: the location is the web page URL that the name was found in.

The output is arranged so the User 10 of the System 1 can quickly see people's names and titles that were extracted. Names are highlighted in green text and titles in red text.

Advantages

The previously described version of the present invention has many advantages. The System is a better method of extracting data from electronically stored text sources, especially from web pages.

Although the present invention has been described in considerable detail with reference to certain preferred versions thereof, other versions are possible. For example, the functionality and look of the System 1 could be different or new protocols or different data structures can be used or different databases could be used. Therefore, the point and scope of the appended claims should not be limited to the description of the preferred versions contained herein.

That which is claimed is:

1. A system for extracting data from electronically sources comprising: a processing system using a plurality of component parts working in conjunction producing extraction results.

2. A system according to claim 1 in which said source is a website.

3. A system according to claim 1 in which said component parts include a plurality of databases.

4. A system according to claim 3 in which said databases includes a names database.

5. A system according to claim 3 in which said databases includes an additional words database.

6. A system according to claim 3 in which said databases includes a titles database.

7. A system according to claim 3 in which said databases includes a plurality of small databases.

8. A system according to claim 3 in which said databases includes a famous people database.

9. A system according to claim 3 in which said databases includes a historic figure database.

10. A system according to claim 1 in which said processing system a uses an extraction algorithm.

11. A system according to claim 1 in which said processing system a uses a substring scoring algorithm.

12. A system according to claim 1 in which said processing system a uses a final name scoring algorithm.

13. A system according to claim 1 in which said processing system a uses a plurality of user interface elements.

14. A system according to claim 1 in which said processing system a uses a substring score threshold increments user interface element.

15. A system according to claim 1 in which said processing system a uses a substring score decrements user interface element.

16. A system according to claim 1 in which said processing system a uses a substring score special cases user interface element.

17. A system according to claim 7 in which said small databases includes a postal databases.

18. A system according to claim 7 in which said small databases includes a direction database.

19. A system according to claim 7 in which said small databases includes a time database.

20. A system for extracting data from electronically sources comprising: a processing system using a plurality of component parts working in conjunction producing extraction results, said conjunction parts including a plurality of databases, a plurality of algorithms and a plurality of user interface elements, where said databases includes an additional words database, a titles database a famous people database, and a historic figure database; said algorithms includes an extraction algorithm, a substring scoring algorithm and a final name scoring algorithm; and said user interface elements include a substring score threshold increments user interface element, a substring score decrements user interface element, and a substring score special cases user interface element.
